(19) United States
(12) Patent Application Publication
(10) Pub. No.: US 2024/0154227 A1
(43) Pub. Date: May 9, 2024

(54) Stored Energy Source Housing, Motor Vehicle, Stored Electrical Energy Source, and Class

(71) Applicant: Bayerische Motoren Werke Aktiengesellschaft, Muenchen (DE)

(72) Inventors: Manuel ANASENZL, Mainburg (DE); Ahmed EL-SAWY, Muenchen (DE); Manuel SCHURZ, Landshut (DE); Marcel STERZENBACH, Essenbach (DE)

(21) Appl. No.: 18/281,869

(22) PCT Filed: Feb. 22, 2022
(86) PCT No.: PCT/EP2022/054302

§ 371 Date: Sep. 13, 2023

(30) Foreign Application Priority Data
Mar. 23, 2021 (DE) 10 2021 107 100.3

(51) Int. Cl. H01M 50/213; B60K 1/04; B60L 50/60; B60L 50/64; B60N 2/005; B62D 25/20; H01M 50/224; H01M 50/227; H01M 50/249

(52) U.S. Cl. CPC H01M 50/213; B60K 1/04; B60L 50/64; B60L 50/66; B60N 2/005; B62D 25/20; H01M 50/224; H01M 50/227; H01M 50/249; B60K 2001/0438; H01M 2220/20

(57) ABSTRACT

A stored energy source housing, in particular a high-voltage accumulator housing for a motor vehicle, has a top housing part and a bottom housing part. The bottom housing part has a middle portion and two end portions. The middle portion has a base element on which wall elements are formed laterally and extend along a longitudinal axis. As a result, together with the base element, an arrangement space is formed in regions, and the end portions are arranged at the ends of the middle portion and have wall elements which also form the arrangement space. The end portions are cast parts, and the shape of the middle portion is produced by bending.

### BACKGROUND AND SUMMARY

The present invention relates to an energy store housing, in particular a high-voltage accumulator housing for a motor vehicle, to a motor vehicle, to an electrical energy store, and to a series of energy store housings.

Energy store housings of the type in question are used, e.g., in partly and fully electrified motor vehicles. Installed in such housings are the batteries or battery modules. In order to achieve the required ranges, the stores and respective housings are often very large, which is not unproblematic with regard to economical series production. The production of such housings is not unproblematic since, among other things, the housings have to meet high gas-tightness requirements.

It is therefore an object of the present invention to provide an energy store housing, a motor vehicle, an electrical energy store and a series of energy store housings, which allow efficient production while simultaneously meeting the highest quality requirements.

This object is achieved by an energy store housing, by a motor vehicle, by an electrical energy store, and by a series of energy store housings, in accordance with the independent claims. Further advantages and features are evident from the dependent claims and from the description and the appended figures.

According to the invention, an energy store housing, in particular a high-voltage accumulator housing for a motor vehicle, comprises a top housing part and a bottom housing part, wherein the bottom housing part has a middle portion and two end portions, wherein the middle portion comprises a base element on which wall elements are formed laterally and extend along a longitudinal axis, as a result of which, together with the base element, an arrangement space is formed in regions, and wherein the end portions are arranged at the ends of the middle portion and have wall elements which also form the arrangement space, wherein the end portions are cast parts, and wherein the shape of the middle portion is produced by bending. The arrangement space is expediently closed at the top by the top housing part which is fastened to the bottom housing part in a suitable manner. The middle portion formed by bending and the cast end portions advantageously allow a substantially parallelepipedal arrangement space. Such a parallelepipedal arrangement space, which does not have any relatively large radii, etc., allows a maximum transport volume. In other words, a very high number of energy storage cells can thus be arranged since disruptive radii, such as occur for example in the case of deep-drawing, can be avoided in the case of bending or in particular in the case of edge bending.

According to one embodiment, the middle portion is a bent plastic and/or metal part. According to a preferred embodiment, the metal part is a steel sheet or in particular an aluminum sheet which is suitably bent or in particular formed by bending or is correspondingly edge-bent. The middle portion can also be referred to as an edge part. The wall elements extend perpendicularly or substantially perpendicularly away from the base element.

Alternatively, the middle portion can also be produced from plastic or from a composite material, such as for example from a carbon-fiber-reinforced plastic. According to one embodiment, the middle portion is embodied for example as an SMC (Sheet Molding Compound) component. The shaping occurring here in the SMC tool is also interpreted as bending. In addition, plastic or composite components can also be bent or edge-bent.

According to one embodiment, flange elements are formed adjoining the wall elements and are preferably oriented parallel to the base element. These flange elements preferably extend away from the arrangement space, parallel to the base element, and form a flange or flange region. The flange elements, which are in particular formed so as to surround the arrangement space and which are formed both on the middle portion and on the end portions, advantageously form a surrounding flange region. Expediently, the top housing part is fastened to the bottom housing part, in particular in a gas-tight, form-fitting and/or force-fitting manner. Expediently, the fastening or connection is formed so as to be detachable. Preferred fastening means comprise screw and/or rivet connections. The bent or in particular edge-bent middle portion, comprising the wall elements and the adjoining flange portions, has a very high dimensional accuracy due to the method. The flatness of the surfaces should in particular be highlighted in this context. The flange elements in particular are very flat and especially not wavy, as would be the case for example when deep-drawing such a structure. Flange elements which are not dimensionally accurate or in particular wavy would prevent the top housing part being arranged tightly or at least make this more difficult.

In order to fasten the top housing part, one or more fastening elements are formed on the flange elements or on the flange region. These fastening elements here may be correspondingly formed recesses or holes which serve for the arrangement of fasteners, such as screws. Furthermore, the flange elements or the flange region also serve to fasten the energy store housing in the respective motor vehicle. For example, the flange elements, in particular the lateral flange elements, or the corresponding flange regions, are used to fasten the energy store housing to the longitudinal beams of the motor vehicle.

According to a preferred embodiment, the end portions are produced as one part, in particular by die casting. Expediently, the end portions are made from a metal material, in particular from a lightweight metal, such as an aluminum alloy for example. Alternatively, production from a plastic or in particular from a composite material is also preferred. In relation to the direction of travel, when the energy store housing is installed in the motor vehicle, there is a front portion and a rear end portion. The end portions can be designed such that they are identical at the front and the rear. Typically, however, they differ at least slightly since they have or form different attachment points. Nevertheless, they can expediently be produced initially as one part. In order to produce the two end portions, this one part, which according to a preferred embodiment is a die-cast component, is mechanically separated. A preferred separation method here is for example sawing.

The end portions expediently comprise wall elements since they also form the arrangement space. Preferably, but not necessarily, they also have flange elements. Expediently, they are thus designed to continue or to complete a shape or geometry of the middle portion. According to a preferred embodiment, the end portions also have base elements.

According to one embodiment, the end portions are connected to the middle portion in a materially bonded manner along a joining plane, wherein the joining plane is sealed. According to a preferred embodiment, the end portions are connected to the middle portion in a form-fitting and/or force-fitting manner, in particular screwed and/or riveted.

According to a particularly preferred embodiment, the end portions are fastened to the middle portion by a fusion welding method, in particular by means of MIG welding (metal inert gas welding). This method can be reliably implemented and is inexpensive. The tightness, in particular gas-tightness, at this point or along the weld seam is preferably produced subsequently by a sealing material applied to the connection or joining point. The sealing material is applied, for example, in the form of a bead, along the weld seam, on one or both sides.

According to a preferred embodiment, the joining regions or the joining plane are/is subsequently sealed, wherein a sealing material is used for this purpose. According to a preferred embodiment, the sealing material is selected from one of the following materials: silane-modified polymer, 2C (2-component) polyurea and/or polyvinyl chloride. It has transpired that the aforementioned materials, in particular in connection with the application to, preferably bare, aluminum material, offer optimal fluid-tightness, in particular gas-tightness. Particularly preferred is the use of a sealing material made from or based on silane-modified polymers or a silane-modified polymer.

The configuration advantageously allows a complete bottom housing part, based on only a few components. In this case, the bottom housing part has a base element which is oriented substantially parallel to the roadway plane in the installed state of the energy store housing. The wall elements extend away from the base element substantially perpendicularly (upward in relation to the roadway plane or base plane). Together with the end portions, this thus results in an arrangement space which is closed all around.

According to a preferred embodiment, the joining plane is flat and oriented perpendicular to the base element. This firstly makes it easier to fasten the end portions to the middle portion since work only has to be performed along one line.

At the same time, the optionally subsequent sealing is also made easier since no complicated geometries have to be sealed here either. In combination with the preferred production of the end portions as one part, further advantages can be generated since the two parts have a likewise expediently straight or flat separation plane.

Particularly preferably, the arrangement space is formed free of barriers. Expediently, no further elements, be they transverse elements or longitudinal elements, are thus provided in the arrangement space for reinforcement, etc. The space can be used completely for accommodating as high a number of energy storage cells as possible. Expediently, a multiplicity of energy storage cells are arranged in the arrangement space such that they fill the space. Preferred types of housing cells are for example prismatic cells or in particular round cells which are expediently arranged in particular upright, optionally also in a plurality of planes.

The invention also relates to a motor vehicle, comprising a front-end part and a rear-end part, which parts are connected via longitudinal elements, and wherein an energy store housing according to the invention is fastened to the longitudinal elements, in particular free of load. Expediently, the front-end part and the rear-end part, in combination with the longitudinal elements, form the load-bearing structure, while the energy store housing is arranged on this structure or is fastened to this structure in particular for example in a form-fitting and/or force-fitting manner, in particular also detachably, such that it is entirely free of load. In other words, the energy store housing must not absorb any forces. Instead, consequently, the energy store housing can be primarily designed to accommodate as many energy storage cells as possible.

According to a preferred embodiment, the top housing part of the energy store housing forms a base of the vehicle interior.

According to a preferred embodiment, cross beams are arranged on the top housing part, in particular in a form-fitting and/or force-fitting manner, for example by means of screw connections, wherein the cross beams are designed for the purpose of fastening seat rails. The cross beams are also called seat cross beams. The seat cross beams are expediently connected to the longitudinal elements or are fastened to the latter. The aforementioned structure can also be reinforced in the transverse direction in the region of the energy store housing by this means. Expediently, however, not via the energy store housing itself but via the cross beams to which the energy store housing is fastened solely via its top housing part which, as mentioned, preferably forms the base of the vehicle interior.

The invention also relates to an electrical energy store, in particular a high-voltage accumulator, which comprises an energy store housing according to the invention. Such an electrical energy store comprises a multiplicity of electrical energy storage cells, in the present case for example lithium-ion cells, lithium-sulfur cells, iron phosphate cells, etc. Energy storage cells can however also be capacitors or supercapacitors. According to one embodiment, the energy storage cells are combined to form modules, in particular battery modules. An energy store comprises, e.g., a multiplicity of such battery modules.

According to a preferred embodiment, such a module structure is dispensed with. Instead, the energy storage cells are arranged directly in the arrangement space, wherein the barrier-free arrangement space proposed here, substantially formed by the three parts of a middle portion, front end portion and rear end portion, brings about great advantages with regard to the possible arrangement volume. In particular, a particular advantage to be mentioned here is the lack of interior cross beams or longitudinal beams. The same applies for the very small radii that can be achieved by the bending or edge-bending, which allow optimal utilization of space.

The invention also relates to a series of energy store housings, comprising a multiplicity of energy store housings according to the invention, wherein the width and length of the energy store housings are adjusted by correspondingly formed, in particular bent, middle portions. According to one embodiment, the middle portions differ only in their length. The end portions within the series of this embodiment are preferably identical parts. As already mentioned, the front and rear end portions are expediently each formed differently. Expediently, however, the respective front end portions or the respective rear end portions within the series are formed identically or substantially identically. This does not mean that bores or the like cannot optionally subsequently be made for example, as a result of which the end portions can be appropriately customized. The basic components are each expediently identical, as a result of which differently sized energy store housings for use in differently sized vehicles can be provided in a reliable and inexpensive manner.

Alternatively, the middle portions, in addition or alternatively, have different widths. This can be achieved with little effort since they are formed by bending or in particular edge-bending. The end portions are correspondingly formed so as to be wider or narrower. This can also be implemented with little effort.

Further advantages and features are evident from the following description of embodiments of energy store housings with reference to the appended figures.

### BRIEF DESCRIPTION OF THE DRAWINGS

FIG. 1 is a plan view of one embodiment of a bottom housing part;

FIG. 2 is a section view A-A, as depicted in FIG. 1;

FIG. 3 is a side view B-B of the bottom housing part known from FIG. 1, as depicted in FIG. 1;

FIG. 4 is a plan view of a bottom housing part in the installed state.

### DETAILED DESCRIPTION OF THE DRAWINGS

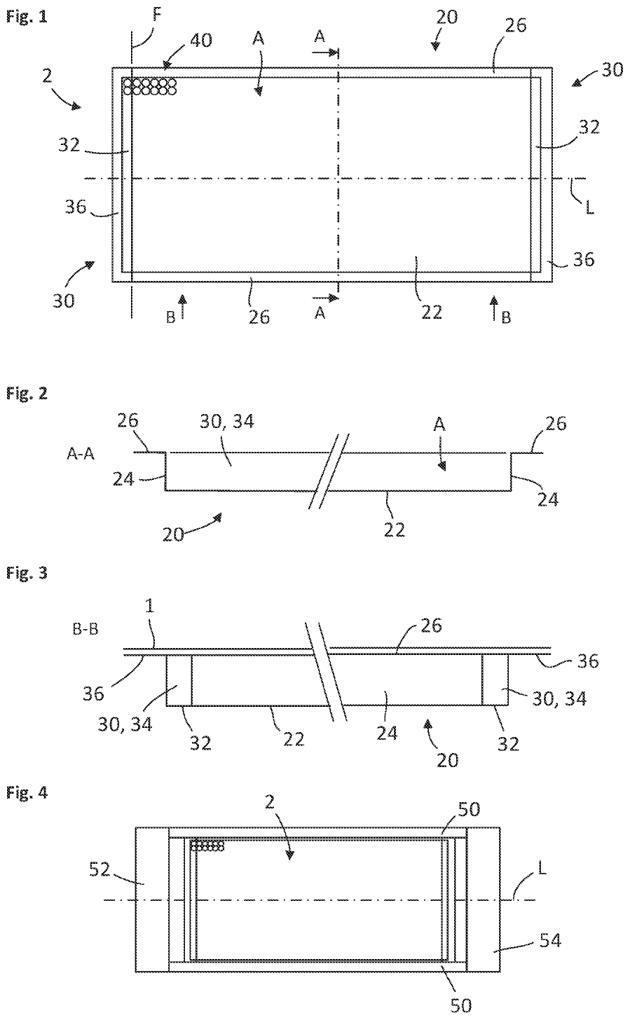

FIG. 1 shows, in a schematic illustration, a plan view of a bottom housing part 2 of an energy store housing. A middle portion 20 which extends along a longitudinal direction L can be seen, wherein an end portion 30 is arranged at each end. The middle portion 20 has a base element 22. In the present case, the end portions 30 are also formed such that they have base elements 32. In combination with wall elements, which in the present case are oriented as it were perpendicularly to the plane of the drawing, a substantially parallelepipedal arrangement space A is formed. This expediently serves to accommodate as high a number of energy storage cells 40 as possible. These are illustrated as round cells in the present case. The end portions 30 are each fastened to the middle portion 20 along a joining region or a joining plane F. This joining plane F is expediently formed so as to be planar or flat. In the present case, it is also substantially perpendicular to the plane of the drawing. The end portions 30 and the middle portion 20 form a surrounding flange region formed by flange elements 26 and 36. The section A-A and the view B-B are illustrated in FIGS. 2 and 3, respectively.

FIG. 2 shows the section A-A depicted in FIG. 1. In particular, a shape of the middle portion 20 can be seen here in cross section. Illustrated is the base element 22, away from which the two wall elements 24 extend perpendicularly upward, wherein the flange elements 26 in turn expediently extend away from these wall elements, parallel to the base element 22. Such a geometry can be achieved in a reliable and effective manner via a bending process. According to a preferred embodiment, the middle portion 20 is therefore formed as an edge-bent metal sheet. In the background of FIG. 2, the advantageously cast end portion 30 or the wall element 34 thereof can be seen. The bending or edge-bending in the present case in particular has the advantage that the flange elements 26 have good flatness. When deep-drawing such structures, the problem arises that the flange elements are too wavy. This results in problems when arranging the top housing part since the required tightness is generally not easily achievable.

FIG. 3 shows the view B-B depicted in FIG. 1. In particular, a side view of the bottom housing part 2 depicted in FIG. 1 is schematically illustrated here. It can be seen here in particular how the end portions 30 also each form wall elements 34 or each form a base element 32. It can be seen that the end portions 30 continue the geometry of the middle portion 20 as it were. Reference sign 1 denotes a top housing part which is arranged or able to be arranged on the flange elements 26 or 36.

FIG. 4 shows, in a schematic view, a bottom housing part 2 in the installed state. A motor vehicle is depicted here by a front-end part 52 and a rear-end part 54, which parts are connected via longitudinal elements 50. The depiction is intended to illustrate that the energy store housing is expediently fastened within this structure free of load. Expediently, the energy store housing must not absorb any loads. According to a preferred embodiment, a top housing part (not illustrated here) of the energy store housing forms a base or floor of a passenger compartment. According to a preferred embodiment, the longitudinal elements 50 are connected in the region of the energy store housing via at least one transverse element which is oriented transverse to the illustrated longitudinal axis L, wherein the structure can be additionally reinforced in the region of the energy store housing; however, not via the energy store housing. Expediently, the energy store housing is fastened via its top housing part 1 to the at least one transverse element. Advantageously, a plurality of such transverse elements are provided. Expediently, the transverse elements serve as fastening points for the seat rails.

### LIST OF REFERENCE SIGNS

1 Top housing part
2 Bottom housing part
20 Middle portion
22 Base element
24 Wall element
26 Flange element
30 End portion
32 Base element
34 Wall element
26 Flange element
40 Energy storage cell
50 Longitudinal element
52 Front-end part
54 Rear-end part
A Arrangement space
F Joining plane
L Longitudinal axis

1.-14. (canceled)

15. A method for producing an energy store housing for a motor vehicle, the housing having a top housing part and a bottom housing part, the method comprising:
shaping, via bending, a middle portion of the bottom housing part, wherein the middle portion comprises a base element with lateral wall elements that extend along a longitudinal axis, as a result of which, together with the base element, an arrangement space is formed in regions; and
producing, via casting, two end portions of the bottom housing, wherein the end portions are arranged at respective longitudinal ends of the middle portion and have wall elements which also form the arrangement space.

16. The method according to claim 15, wherein
the middle portion is a bent plastic and/or metal part.

17. The method according to claim 15, wherein
the middle portion is an edge-bent metal sheet.

18. The method according to claim 15, wherein
flange elements are formed adjoining the wall elements and are oriented parallel to the base element and extend away from the arrangement space parallel to the base element.

19. The method according to claim 18, wherein
at least one fastening element is formed on the flange elements.

20. The method according to claim 18, wherein
the top housing part is fastened to the wall elements and/or to the flange elements.

21. The method according to claim 15, wherein
the end portions are produced as one part, by die casting.

22. The method according to claim 15, wherein
the end portions are connected to the middle portion in a materially bonded manner along a joining plane, and
the joining plane is sealed.

23. The method according to claim 22, wherein
the joining plane is flat and oriented perpendicular to the base element.

24. The method according to claim 15, wherein
the arrangement space is formed free of barriers, and
a multiplicity of energy storage cells are arranged in the arrangement space so as to fill the space.

25. A motor vehicle, comprising:
a front-end part;
a rear-end part;
longitudinal elements connecting the front and rear end parts; and
an energy store housing fastened to the longitudinal elements free of load, wherein the energy store housing comprises a top housing part and a bottom housing part,
wherein the bottom housing part has a middle portion and two end portions,
wherein the middle portion comprises a base element on which wall elements are formed laterally and extend along a longitudinal axis, as a result of which, together with the base element, an arrangement space is formed in regions, and
wherein the end portions are arranged at the ends of the middle portion and have wall elements which also form the arrangement space,
wherein the end portions are cast parts, and
wherein the shape of the middle portion is produced by bending.

26. The motor vehicle according to claim 25, wherein
the top housing part of the energy store housing forms a base of the vehicle interior.

27. The motor vehicle according to claim 25, wherein
cross beams are arranged on the top housing part and are designed for fastening seat rails, and
the cross beams are connected to the longitudinal elements.

28. An electrical energy store comprising an energy store housing produced according to claim 15.

29. A method of producing a series of energy store housings, comprising:
shaping, via bending, a middle portion of a bottom housing part of the series of energy store housings, wherein the middle portion comprises a base element with lateral wall elements that extend along a longitudinal axis, as a result of which, together with the base element, an arrangement space is formed in regions; and
producing, via casting, two end portions of the bottom housing, wherein the end portions are arranged at respective longitudinal ends of the middle portion and have wall elements which also form the arrangement space,
wherein a width and a length of the series of energy store housings are adjusted by differently bent middle portions.

30. A high-voltage accumulator housing for a motor vehicle, comprising:
a top housing part and a bottom housing part,
wherein the bottom housing part has a middle portion and two end portions,
wherein the middle portion comprises a base element on which wall elements are formed laterally and extend along a longitudinal axis, as a result of which, together with the base element, an arrangement space is formed in regions, and
wherein the end portions are arranged at the ends of the middle portion and have wall elements which also form the arrangement space,
wherein the end portions are cast parts, and
wherein the shape of the middle portion is produced by bending.

31. The housing according to claim 30,
wherein the middle portion is a bent plastic and/or metal part.

32. The housing according to claim 30,
wherein flange elements are formed adjoining the wall elements and are oriented parallel to the base element and extend away from the arrangement space parallel to the base element.

33. The e housing according to claim 30,
wherein the end portions are produced as one part by die casting.
